(19) United States
(12) Patent Application Publication
(10) Pub. No.: US 2007/0156741 A1
(43) Pub. Date: Jul. 5, 2007

(54) System and method for recording terminal time and establishing usage profiles across systems and applications

(75) Inventor: Patrick O'Sullivan, Dublin (IE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/318,972

(22) Filed: Dec. 27, 2005

(51) Int. Cl. G06F 7/00

(52) U.S. Cl. 707/102

(57) ABSTRACT

Embodiments of the present invention address deficiencies of the art in respect to time card systems and provide a novel and non-obvious method, system and computer program product for computing employee work patterns through presence and place awareness. In one embodiment of the invention, a method for computing employee work patterns through presence and place awareness can be provided. In the method presence awareness data can be repeatedly collected for an employee already logged into a computing system. Subsequently, a time card can be generated for the employee based upon the repeatedly collected presence awareness data.

### BACKGROUND OF THE INVENTION

1. Field of the Invention

The present invention relates to the field of time card systems and more particularly to electronically tracking employee work attendance through an employee computing workstation.

2. Description of the Related Art

Time card systems provide a mechanism for employers to track the attendance of employees in a semi-automated way. Generally, in a time card system, an employee “punches in” whenever the employee arrives at the workplace. Conversely, an employee “punches out” whenever the employee departs the workplace. Time spent by the employee in the workplace can be determined from the times recorded from successive punch-in and punch-out operations. In this way, the employer can track the attendance record for employees without having to dedicate personnel to visually account for each employee during times of work.

More advanced forms of time card systems avoid the use of ancillary equipment and rely upon the network login and logoff activities of employees. In a common form of the network based time card system, the logging in operation for an employee can be interpreted by the time card system as a “punch in” whereas the logging out”. Notwithstanding, an the common form of the network based time card system, the ability to track the attendance of an employee relies largely on the employee adhering to a strict logon and logoff cycle each day. Yet, for many employees, a logon each morning does not occur because the employees frequently fail to logoff each evening. Rather, many employees remain perpetually logged into the company network throughout the work week.

Despite the raw ability of time card systems to track the arrival and departure of employees, time card systems generally cannot account for the work habits of employees. Specifically, it is well known that employees engage in work related activities for only a portion of the time employees are present in the workplace. At other times, employees engage in social activities, enjoy breaks, both sanctioned and unsanctioned, and, in many cases, temporarily depart the workplace for short periods of time. Time cards are woefully unprepared to account for this behavior due to reliance upon employees to engage in punch-in and punch-out operations. Accordingly, management cannot rely upon the attendance data provided by time card systems when engaging in strategic planning.

### BRIEF SUMMARY OF THE INVENTION

Embodiments of the present invention address deficiencies of the art in respect to time card systems and provide a novel and non-obvious method, system and computer program product for computing employee work patterns through presence and place awareness. In one embodiment of the invention, a method for computing employee work patterns through presence and place awareness can be provided. In the method presence awareness data can be repeatedly collected for an employee already logged into a computing system. Subsequently, a time card can be generated for the employee based upon the repeatedly collected presence awareness data.

In one aspect of the embodiment, place awareness data can be repeatedly collected for the employee already logged into the computing system. As such, the repeatedly collected place awareness data can be reduced for strategic information technology planning. In this regard, repeatedly collecting presence and place awareness data for an employee already logged into a computing system can include repeatedly collecting presence and place awareness data from a collaborative tool for an employee already logged into a computing system. For instance, the collaborative tool can be an instant messenger.

In another embodiment of the invention, a data processing system can be configured for computing employee work patterns. Specifically, the system can include presence awareness logic coupled to a client computing device hosting one or more applications. A server computing device can be communicatively coupled to the client computing device over a computer communications network and a data store can be coupled to the server computing device. Notably, a data acquisition process can be disposed in the server computing device and can include program code enabled to acquire presence awareness data from the presence awareness logic and store the acquired presence awareness data in the data store. Likewise, a data reduction process can be disposed in the server computing device and can include program code enabled to compute time cards from the acquired presence awareness data stored in the data store.

In one aspect of the embodiment, the system further can include place awareness logic coupled to the client computing device. As such, the data acquisition process further can include program code enabled to acquire place awareness data from the place awareness logic and store the acquired place awareness data in the data store. Moreover, the data reduction process further can include program code enabled to compute strategic information technology planning from the acquired place awareness data stored in the data store.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a computing environment arranged for computing employee work patterns through presence and place awareness;

FIG. 2 is a schematic illustration of a data processing system configured for computing employee work patterns through presence and place awareness; and,

FIG. 3 is a flow chart illustrating a process for computing employee work patterns through presence and place awareness.

### DETAILED DESCRIPTION OF THE INVENTION

Embodiments of the present invention provide a method, system and computer program product computing employee work patterns through presence and place awareness. In accordance with an embodiment of the present invention, presence awareness data for an employee can accumulated for the employee to compute a period of time when the employee actively interacts with an employee computer in the workplace. Also, place awareness data for the employee can be accumulated to identify applications with which the employee actively interacts with the employee computer. Utilizing the computed time and identified applications for each employee, strategic management decisions can be executed, including more accurately tracking employee attendance and monitoring application usages on an employee, department, or temporal basis.

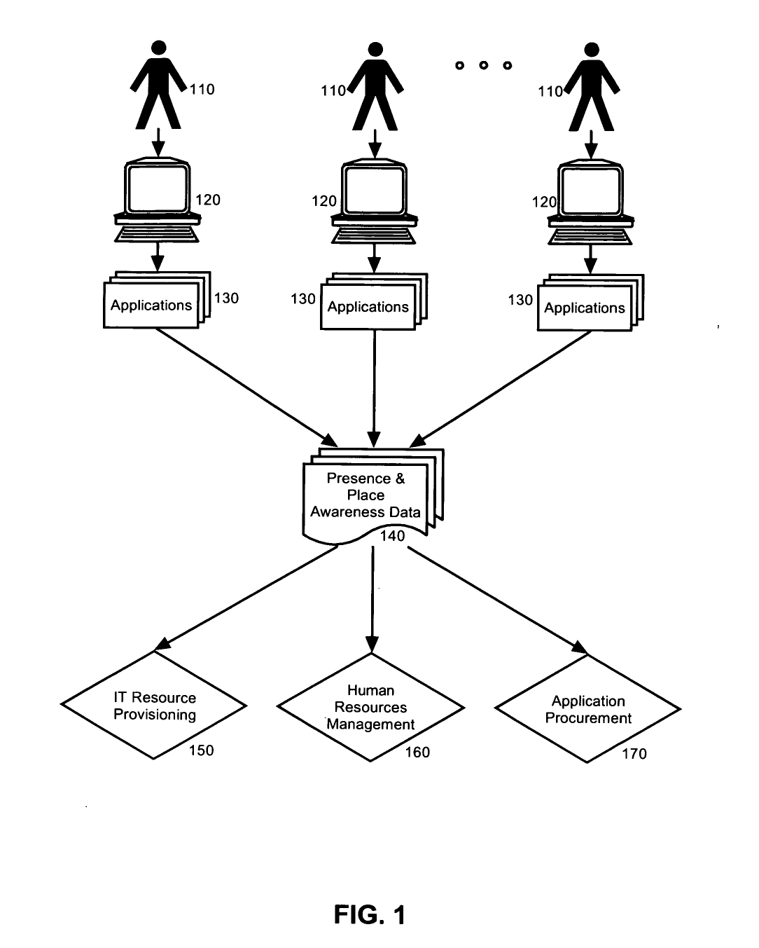

In more particular illustration, FIG. 1 depicts a computing environment arranged for computing employee work patterns through presence and place awareness. As shown in FIG. 1, employee computing users 110 can interact with one or more computing applications 130 disposed within associated computing devices 120. Presence and place awareness data 140 can be acquired whenever the employee computing users 110 interact with the computing applications 130.

Presence awareness commonly refers to the availability and willingness of a computing user to communicate and has wide application in voice over Internet protocol (IP) and instant messaging. Place awareness, in turn, commonly refers to the recognition of a markup language specified page, a document, a forum, a Web site or an application utilized by a computing user and similarly has wide application in instant messaging and collaboration environments such as the Lotus™ Notes™ environment. Lotus and Notes are registered trademarks of International Business Machines Corporation of Armonk, N.Y., United States.

In this regard, the presence awareness portion of the presence and place awareness data 140 can provide an indication of when the employee computing users 110 actively utilize the resources of the associated computing devices 120. The place awareness portion of the presence and place awareness data 140, in turn, can provide an indication of with which applications 130 the employee computing users 110 interact. Utilizing both, strategic information technology (IT) and human resources (HR) planning can be undertaken, including IT resource provisioning 150 based upon employee computing activity for employee end users 110, HR management 160 including employee time card tracking, and application procurement 170 based upon application usage patterns for the employee end users 110.

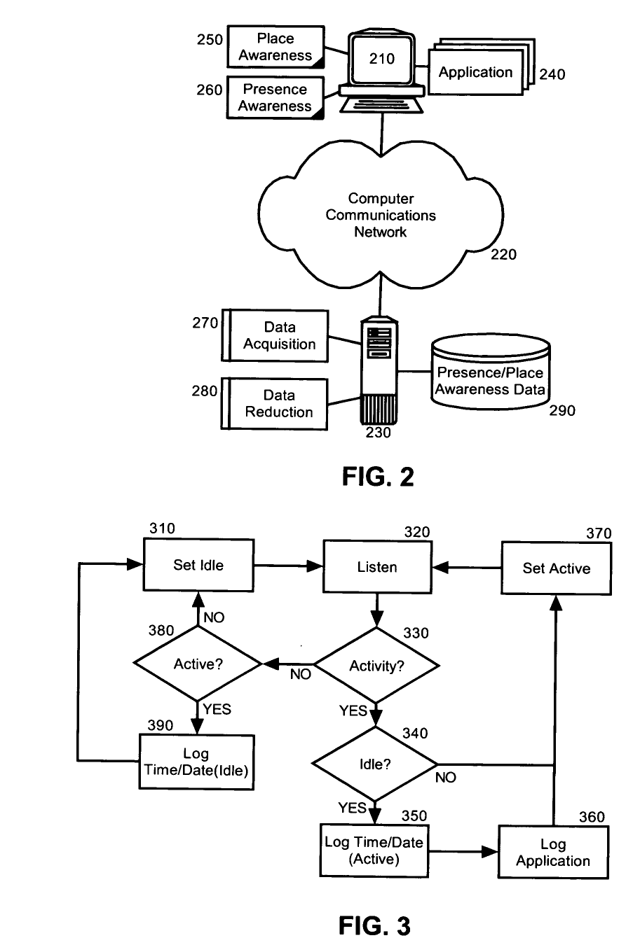

The computing environment of FIG. 1 can be enabled through the arrangement of a data processing system configured for computing employee work patterns through presence and place awareness. In further illustration, FIG. 2 is a schematic illustration of a data processing system configured for computing employee work patterns through presence and place awareness. As shown in FIG. 2, the data processing system can include a host computing platform 230 communicatively coupled to a client computing platform 210 over a computer communications network 220. The client computing platform 210 can host the operation of one or more applications 240 for use by an end user.

Notably, the client computing platform 210 also can include place awareness logic 250 and presence awareness logic 260. The place awareness logic 250 can include program code enabled to publish the availability and willingness of the end user to communicate with other computing devices over the computer communications network 220. For example, the place awareness logic 250 can be included as part of an instant messenger or other collaborative tool and can detect activity on the part of the end user in the client computing platform 210. In contrast, the place awareness logic 250 can include program code enabled to publish the identity of a markup language specified page, a document, a forum, a Web site or an application utilized by the end user in the client computing platform 210.

The server computing platform 230 can include a data acquisition process 270 enabled to receive presence awareness data and place awareness data from the client computing platform 210 in addition to other communicatively coupled client computing platforms (not shown for the sake of illustrative simplicity). The data acquisition process 270 further can store the acquired presence awareness data and place awareness data in a data store 290. Finally, the server computing platform 230 can include a data reduction process 280. The data reduction process 280 can be enabled to process the presence awareness data and the place awareness data in the data store 290 to provide for strategic IT and HR management including accurate employee time card tracking beyond merely logging into and out of a network.

In yet further illustration, FIG. 3 is a flow chart illustrating a process for computing employee work patterns through presence and place awareness. Beginning in block 310, the status of the employee can be set to idle as the employee will not yet have interacted with the host computing environment. In block 320, the state of the host computing environment can be monitored to detect activity on the part of the employee. In decision block 330, if activity is detected in the host computing environment, the process can branch to decision block 380. Otherwise, the process can continue through decision block 340.

In decision block 340, if the employee had been considered idle, the time and date can be logged for the detection of the activity in block 350 and in block 360, the application associated with the activity further can be logged. Subsequently, in block 370 the status of the employee can be set to active as the employee now actively interacts with the host computing environment. Thereafter, the process can continue in block 320 in which the state of the host computing environment can be monitored to detect activity on the part of the employee. In decision block 330, when idleness is determined based upon inactivity on the part of the employee, the process can branch to decision block 380.

In decision block 380, if the employee had been considered active, the time and data can be logged for the detection of the activity in block 390. Subsequently, in block 310, the status of the employee can be set to idle as the employee no longer actively interacts with the host computing environment. In consequence, the actual presence of the employee in a working posture can be tracked rather than merely tracking the proximity of the employee to the workplace. Moreover, by monitoring place awareness for the employee strategic IT decisions can be founded upon helpful resource usage data collected through place awareness.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for computing employee work patterns through presence and place awareness, the method comprising:
repeatedly collecting presence awareness data for an employee already logged into a computing system; and,
generating a time card for the employee based upon the repeatedly collected presence awareness data.

2. The method of claim 1, further comprising:
repeatedly collecting place awareness data for the employee already logged into the computing system; and,
reducing the repeatedly collected place awareness data for strategic information technology planning.

3. The method of claim 1, wherein repeatedly collecting presence awareness data for an employee already logged into a computing system, comprises repeatedly collecting presence awareness data from a collaborative tool for an employee already logged into a computing system.

4. The method of claim 1, wherein repeatedly collecting presence awareness data for an employee already logged into a computing system, comprises repeatedly collecting presence awareness data from an instant messenger for an employee already logged into a computing system.

5. The method of claim 2, wherein repeatedly collecting place awareness data for an employee already logged into a computing system, comprises repeatedly collecting place awareness data from a collaborative tool for an employee already logged into a computing system.

6. The method of claim 2, wherein repeatedly collecting place awareness data for an employee already logged into a computing system, comprises repeatedly collecting place awareness data from an instant messenger for an employee already logged into a computing system.

7. The method of claim 2, wherein reducing the repeatedly collected place awareness data for strategic information technology planning, comprises reducing the repeatedly collected place awareness data for information technology resource planning.

8. The method of claim 2, wherein reducing the repeatedly collected place awareness data for strategic information technology planning, comprises reducing the repeatedly collected place awareness data for application procurement planning.

9. A data processing system configured for computing employee work patterns comprising:
presence awareness logic coupled to a client computing device hosting a plurality of applications;
a server computing device communicatively coupled to the client computing device over a computer communications network;
a data store coupled to the server computing device;
a data acquisition process disposed in the server computing device, the data acquisition process comprising program code enabled to acquire presence awareness data from the presence awareness logic and store the acquired presence awareness data in the data store; and,
a data reduction process disposed in the server computing device, the data reduction process comprising program code enabled to compute time cards from the acquired presence awareness data stored in the data store.

10. The system of claim 9, further comprising place awareness logic coupled to the client computing device.

11. The system of claim 10, wherein:
the data acquisition process further comprises program code enabled to acquire place awareness data from the place awareness logic and store the acquired place awareness data in the data store; and,
the data reduction process further comprises program code enabled to compute strategic information technology planning from the acquired place awareness data stored in the data store.

12. A computer program product comprising a computer usable medium having computer usable program code for computing employee work patterns through presence and place awareness, said computer program product including:
computer usable program code for repeatedly collecting presence awareness data for an employee already logged into a computing system; and,
computer usable program code for generating a time card for the employee based upon the repeatedly collected presence awareness data.

13. The computer program product of claim 12, further comprising:
computer usable program code for repeatedly collecting place awareness data for the employee already logged into the computing system; and,
computer usable program code for reducing the repeatedly collected place awareness data for strategic information technology planning.

14. The computer program product of claim 12, wherein the computer usable program code for repeatedly collecting presence awareness data for an employee already logged into a computing system, comprises computer usable program code for repeatedly collecting presence awareness data from a collaborative tool for an employee already logged into a computing system.

15. The computer program product of claim 14, wherein the computer usable program code for repeatedly collecting presence awareness data for an employee already logged into a computing system, comprises computer usable program code for repeatedly collecting presence awareness data from an instant messenger for an employee already logged into a computing system.

16. The computer program product of claim 14, wherein the computer usable program code for repeatedly collecting place awareness data for an employee already logged into a computing system, comprises computer usable program code for repeatedly collecting place awareness data from a collaborative tool for an employee already logged into a computing system.

17. The computer program product of claim 14, wherein the computer usable program code for repeatedly collecting place awareness data for an employee already logged into a computing system, comprises computer usable program code for repeatedly collecting place awareness data from an instant messenger for an employee already logged into a computing system.

18. The computer program product of claim 14, wherein the computer usable program code for reducing the repeatedly collected place awareness data for strategic information technology planning, comprises computer usable program code for reducing the repeatedly collected place awareness data for information technology resource planning.

19. The computer program product of claim 14, wherein the computer usable program code for reducing the repeatedly collected place awareness data for strategic information technology planning, comprises computer usable program code for reducing the repeatedly collected place awareness data for application procurement planning.
